(19) United States
(12) Patent Application Publication
(10) Pub. No.: US 2005/0091995 A1
(43) Pub. Date: May 5, 2005

(54) Apparatus for generating heat of refrigerator and control method thereof

(75) Inventor: Jin-Sung Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/975,436

(22) Filed: Oct. 29, 2004

(30) Foreign Application Priority Data
Nov. 4, 2003 (KR) 77619/2003

(51) Int. Cl. F25B 49/00; G01K 13/00

(52) U.S. Cl. 62/126; 62/129

(57) ABSTRACT

An apparatus for generating heat and a control method thereof capable of reducing the cost and simplifying coupling by using a cheap diode for lowering an applied voltage of a lamp instead of using an expensive capacitor used for the apparatus for generating heat for low temperature compensation includes: a door opening/closing sensor for sensing whether a refrigerator door is opened or closed; a temperature sensor for sensing a temperature of outside air; a control unit for outputting a control signal for driving a lamp upon receiving a signal of the door opening/closing sensor and outputting a control signal for low temperature compensation upon receiving a signal of the temperature sensor; a switch controlled to be turned on by the control signal for driving the lamp; a relay controlled to be turned on by the control signal for low temperature compensation; a lamp connected in series with the switch and the relay and performing lighting and heat generation operations; and a diode connected in series with the relay and half-wave rectifying the power applied to the lamp.

### BACKGROUND OF THE INVENTION

1. Field of the Invention

The present invention relates to a refrigerator, and more particularly, to an apparatus for generating heat of a refrigerator and a control method thereof capable of reducing the cost and simplifying a structure by using a lamp and a diode for lowering an applied voltage.

2. Description of the Background Art

In general, a refrigerator is divided into a freezing chamber for storing frozen food and a chilling chamber for storing chilled food, and a freezing cycle is provided therein to supply cool air to the freezing chamber and the chilling chamber.

Such a refrigerator is classified into a direct cooling type refrigerator employing a way of natural convection in which a cooling operation is performed by making air inside the refrigerator directly contact with an evaporator and an indirect cooling type refrigerator in which the cooling operation is performed by forming a duct, which cool air circulates through, inside the refrigerator and forcibly sending the cool air to the inside of the refrigerator by a blast fan.

The direct cooling type refrigerator is typically used for a small refrigerator having a small volume and the indirect cooling type refrigerator is typically used for a large refrigerator having a large volume.

FIG. 1 is a view showing a freezing cycle of the conventional direct cooling type refrigerator. As shown therein, a main body of a refrigerator is divided into an upper freezing part and a lower chilling part, at which a freezing chamber evaporator and a chilling chamber evaporator are installed. In addition, a condenser, a radiator, is installed at a rear surface of the exterior of the refrigerator, and a chamber having a compressor or the like is disposed at a rear surface of a lower portion of the refrigerator.

Both the freezing evaporator installed at the freezing chamber and the chilling chamber evaporator installed at the chilling chamber are direct cooling plate-shaped evaporators. The freezing evaporator has an area covering the surfaces, i. e. upper and lower surfaces and both side surfaces, other than a rear surface of the freezing chamber and a door. Namely, the freezing evaporator is bent in a lattice type to cover the upper and lower surfaces and the both side surfaces of the freezing chamber. The chilling chamber evaporator has a small area compared to the freezing chamber evaporator and is attached to a rear surface of the chilling chamber.

Heat from a high temperature high pressure refrigerant discharged from the compressor radiates passing through the condenser and pressure of the refrigerant is reduced passing through a capillary tube, whereby the high temperature high pressure refrigerant becomes a low temperature low pressure refrigerant.

The low temperature low pressure refrigerant firstly absorbs heat passing through the evaporator of the freezing chamber, absorbs heat again passing through the evaporator of the chilling chamber, and is sucked into the compressor.

In the direct cooling type refrigerator, a surface temperature of an inner wall at which the evaporator for chilling of the chilling chamber is mounted is sensed, and according to the sensed temperature, an operation of the compressor is controlled.

Namely, the direct cooling type refrigerator is designed to remain at a temperature of −18° C. and 3° C. for the freezing chamber and the chilling chamber, respectively. According to the temperature sensed at the inner wall of the chilling chamber, driving of the compressor is on/off, so that the temperature of the freezing chamber and the chilling chamber remains at a set temperature.

However, when outside air is below 10° C., an external load of the chilling chamber is significantly reduced in comparison to that of the freezing chamber. Therefore, there is a problem that the compressor is turned off before a temperature inside the freezing chamber reaches −18° C. Namely, because there are not many external loads of the chilling chamber, a temperature inside the chilling chamber easily reaches 3° C., which causes the compressor not to operate before the temperature of the chilling chamber reaches a target temperature.

Accordingly, in the conventional direct cooling refrigerator, a temperature which a temperature sensor senses is raised using a lamp mounted at the chilling chamber in case that weak cooling occurs before the temperature of the freezing chamber reaches the target temperature because a temperature around the refrigerator is relatively low.

The lamp is used for lighting when a door of the chilling chamber is opened. It also functions as low temperature compensation for raising a temperature which the temperature sensor senses.

FIG. 2 is a schematic diagram showing a construction of a lamp heat generating apparatus of the conventional refrigerator. As shown therein, if the lamp mounted at the chilling chamber consumes the rectified power, the temperature inside the chilling chamber is considerably raised to have a bad effect on controlling a temperature of the refrigerator. Accordingly, when the door of the refrigerator is closed, a switch is turned off and a relay is turned on such that a voltage is applied to both a lamp and a capacitor. Therefore, the lamp consumes the power lower than the rectification input to raise the temperature sensed by the temperature sensor of the refrigerator.

However, since the capacitor which is used to lower the lamp is expensive, economical efficiency is lowered. In addition, since the capacitor is comparatively bulky, a coupling structure is large and complicated.

### SUMMARY OF THE INVENTION

Therefore, an object of the present invention is to provide an apparatus for generating heat and a control method thereof capable of reducing the cost and simplifying coupling by using a cheap diode for lowering an applied voltage of a lamp instead of using an expensive capacitor used for the apparatus for generating heat for low temperature compensation.

To achieve these and other advantages and in accordance with the purpose of the present invention, as embodied and broadly described herein, there is provided an apparatus for generating heat of a refrigerator, comprising: a door opening/closing sensor for sensing whether a refrigerator door is opened or closed; a temperature sensor for sensing a temperature of outside air; a control unit for outputting a control signal for driving a lamp upon receiving a signal of the door opening/closing sensor and outputting a control signal for low temperature compensation upon receiving a signal of the temperature sensor; a switch controlled to be turned on by the control signal for driving the lamp; a relay controlled to be turned on by the control signal for low temperature compensation; a lamp connected in series with the switch and the relay and performing lighting and heat generation operations; and a diode connected in series with the relay and half-wave rectifying the power applied to the lamp.

To achieve these and other advantages and in accordance with the purpose of the present invention, as embodied and broadly described herein, there is provided a control method of the apparatus for generating heat of the refrigerator, comprising: a first step of measuring a temperature of outside air and comparing the measured temperature with a set temperature; a second step of determining whether a door is opened or closed; and a third step of turning on/off a relay, a diode and a switch connected in series with a lamp for heat generation and lighting according to the results of the first and second steps.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a view showing a freezing cycle of the conventional direct cooling type refrigerator;

FIG. 2 is a schematic diagram showing a construction of a lamp heat generating apparatus of the conventional refrigerator;

FIG. 3 is a construction view illustrating a direct cooling type refrigerator in accordance with the present invention;

FIG. 4 is a schematic view showing a construction of an apparatus for generating heat of the refrigerator in accordance with the present invention; and

FIG. 5 is a flowchart illustrating a control method of the apparatus for generating heat of the refrigerator in accordance with the present invention.

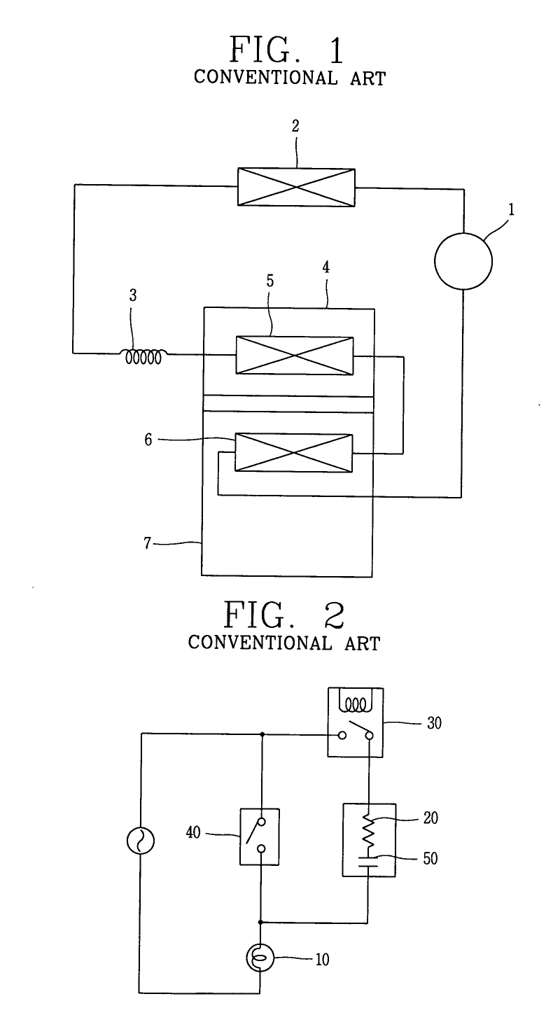

### DETAILED DESCRIPTION OF THE PREFERRED EMBODIMENTS

Reference will now be made in detail to the preferred embodiments of the present invention, examples of which are illustrated in the accompanying drawings. There can be a plurality of embodiments in accordance with the present invention, and, hereinafter, the most preferable embodiment will be described.

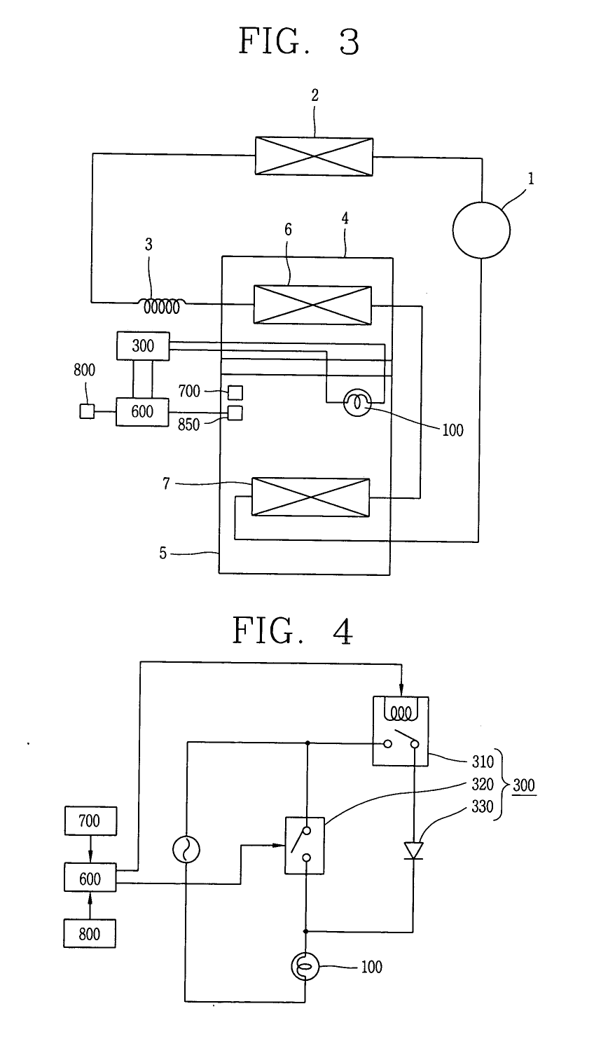

FIG. 3 is a construction view illustrating a direct cooling type refrigerator in accordance with the present invention. As shown therein, a main body of a refrigerator is divided into an upper freezing part and a lower chilling part, at which a freezing chamber evaporator and a chilling chamber evaporator are installed. In addition, a condenser, a radiator, is installed at a rear surface of the exterior of the refrigerator, and a chamber having a compressor or the like is disposed at a rear surface of a lower portion of the refrigerator.

Heat from a high temperature high pressure refrigerant discharged from the compressor radiates passing through the condenser and pressure of the refrigerant is reduced passing through a capillary tube, whereby the high temperature high pressure refrigerant becomes a low temperature low pressure refrigerant. The low temperature low pressure refrigerant firstly absorbs heat passing through the evaporator of the freezing chamber, absorbs heat again passing through the evaporator of the chilling chamber, and is sucked into the compressor. These processes are the same as those of the conventional art.

A door which can be opened or closed and is installed at the main body of the refrigerator is mounted at one side of the refrigerator. The refrigerator door can be a one-door type that the chilling chamber and the freezing chamber are opened or closed at a time and a two-door type that the chilling chamber and the freezing chamber have doors respectively.

A door opening/closing sensor for sensing whether the door is opened or closed is positioned adjacent to the door and inside the refrigerator. Also, in the refrigerator, a surface temperature of an inner wall at which an evaporator for chilling of the chilling chamber is sensed, and according to the sensed temperature, an operation of the compressor is controlled.

The lamp installed in the refrigerator is used for lighting when a door is opened. Moreover, it also functions as heat generation for raising a temperature which the temperature sensor senses. The lamp is connected to a control unit through circuit elements to be described later.

FIG. 4 is a schematic view showing a construction of an apparatus for generating heat of the refrigerator in accordance with the present invention. As shown therein, the apparatus for generating heat of the refrigerator includes: a door opening/closing sensor for sensing whether a refrigerator door is opened or closed; a temperature sensor for sensing a temperature of outside air; a control unit for outputting a control signal for driving a lamp upon receiving a signal of the door opening/closing sensor and outputting a control signal for low temperature compensation upon receiving a signal of the temperature sensor; a switch controlled to be turned on by the control signal for driving the lamp; a relay controlled to be turned on by the control signal for low temperature compensation; a lamp connected in series with the switch and the relay and performing lighting and heat generation operations; and a diode connected in series with the relay and half-wave rectifying the power applied to the lamp.

The door opening/closing sensor may have a construction that a switch is mechanically short-circuited according to movements of the door or that a state that the door is opened or closed can be seized by determining whether an infrared signal is transmitted or received using infrared rays or the like.

Preferably the temperature sensor is not installed near the compressor or the condenser of which temperatures are higher than the temperature of the outside air. Namely, in order to measure the exact temperature of the outside air, the temperature sensor should be installed in order that operation heat of the compressor or the condenser cannot interfere with the temperature sensor.

A general microprocessor is used as the control unit.

The relay can be replaced with a general switch.

As described above, the lamp functions not only as the lighting when opening the door but also as heat generation to raise the temperature which the temperature sensor installed at the chilling chamber senses.

The diode refers to two-terminal solid-state devices having rectification. The rectification means characteristics that the forward direction in which a current flows smoothly and the reverse direction in which few current flows are discriminated according to the direction of voltages applied to the two terminals.

Hereinafter, an operation of the apparatus for generating heat of the refrigerator in accordance with the present invention will be described as follows.

The temperature sensor senses a temperature around the refrigerator and applies the sensed temperature to the control unit. The door opening/closing sensor senses whether the door is opened or closed, and applies the sensed result to the control unit.

According this, when it is sensed that the door is opened, the control unit applies the control signal for driving the lamp to the switch to turn on the switch. The control unit applies power to the lamp through the switch to turn on the lamp.

Meanwhile, when it is not sensed that the door is opened, if the temperature of the outside air inputted to the temperature sensor is lower than a standard temperature, the control unit applies the control signal for low temperature compensation to the relay and the control signal for driving the lamp to the switch.

Accordingly, the switch is turned off and the relay is turned on to apply the power to the lamp through the diode. At this time, the power is half-wave rectified through the diode and applied to the lamp. Namely, despite the fact that it is not necessary to use the lamp for lighting when the door is closed, the temperature inside the refrigerator is considerably raised if the lamp consumes the rectified power, which leads to have a bad effect on controlling a temperature of the refrigerator. Therefore, the half-wave power is applied to the lamp through the diode.

Hereinafter, a control method of the apparatus for generating heat of the refrigerator will be described as follows.

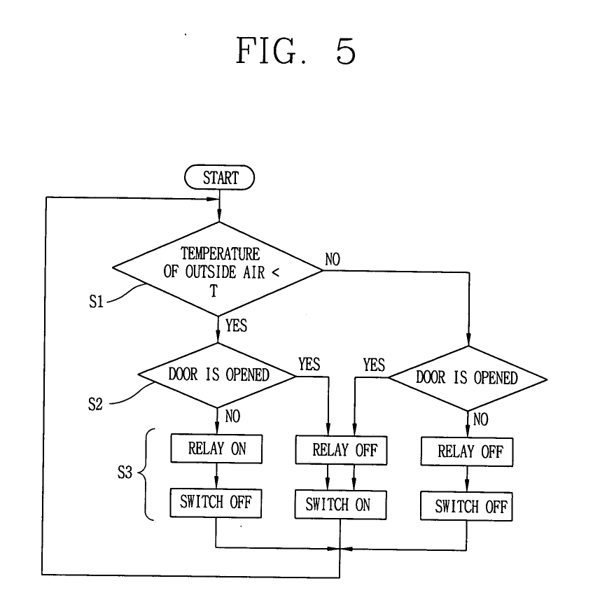

FIG. 5 is a flowchart illustrating a control method of the apparatus for generating heat of the refrigerator in accordance with the present invention.

As shown therein, a control method of the apparatus for generating heat of the refrigerator in accordance with the present invention includes: a first step of measuring a temperature of outside air and comparing the measured temperature with a set temperature; a second step of determining whether a door is opened or closed; and a third step of turning on/off a relay, a diode and a switch connected in series with a lamp for heat generation and lighting according to the results of the first and second steps.

In the first step, the temperature of the outside air read from the temperature sensor is compared to the set temperature, for example, through an OP AMP or the like. Since it can be determined that low temperature compensation is required when the temperature of the outside air is lower than the set temperature, it is necessary to use the lamp for lighting.

The set temperature is preferably 10° C.

In the second step, it is determined whether the door is opened or closed. According to the results of the first and second steps, the control signal for driving the lamp and the control signal for low temperature compensation are applied to each component. When the door is opened, lighting is necessary to draw food out. Therefore, it is determined that the lamp needs to be used for lighting.

In the third step, each component is driven upon receiving the control signal. When it is determined that the temperature of the outside air is lower than the set temperature in the first step and when it is determined that the door is opened in the second step, the relay is turned off and the switch is turned on such that the lamp consumes the power to emit light.

When it is determined that the temperature of the outside air is lower than the set temperature in the first step and when it is determined that the door is closed in the second step, the relay is turned on to operate the lamp through the diode and the switch is turned off.

When it is determined that the temperature of the outside air is higher than or equal to the set temperature in the first step and when it is determined that the door is opened in the second step, the relay is turned off and the switch is turned on such that the lamp consumes the power to emit light.

When it is determined that the temperature of the outside air is higher than or equal to the set temperature in the first step and when it is determined that the door is closed in the second step, the relay is turned off and the switch is turned off such that the lamp does not operate. Namely, since there is no need for light or heat generation, the lamp does not work by breaking a circuit connected to the lamp.

The present invention having such construction can reduce the cost by using the cheap diode for half-wave rectifying the voltage of the lamp and applying the half-wave power instead of using the expensive capacitor for reducing the amount of heat generation of the lamp for low temperature compensation.

In addition, the structure can be further simplified and the coupling structure can be improved by replacing the comparatively bulky capacitor with the diode.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. An apparatus for generating heat of a refrigerator, comprising:
a door opening/closing sensor for sensing whether a refrigerator door is opened or closed;
a temperature sensor for sensing a temperature of outside air;
a control unit for outputting a control signal for driving a lamp upon receiving a signal of the door opening/closing sensor and outputting a control signal for low temperature compensation upon receiving a signal of the temperature sensor;
a switch controlled to be turned on by the control signal for driving the lamp;
a relay controlled to be turned on by the control signal for low temperature compensation;
a lamp connected in series with the switch and the relay and performing lighting and heat generation operations; and
a diode connected in series with the relay and half-wave rectifying the power applied to the lamp.

2. The apparatus of claim 1, wherein the door opening/closing sensor is a switch to be mechanically short-circuited according to movements of the door

3. The apparatus of claim 1, wherein the door opening/closing sensor is an infrared sensor capable of seizing a state that the door is opened or closed by determining whether an infrared signal is transmitted or received.

4. A control method of the apparatus for generating heat of the refrigerator, comprising:
a first step of measuring a temperature of outside air and comparing the measured temperature with a set temperature;
a second step of determining whether a door is opened or closed; and
a third step of turning on/off a relay, a diode and a switch connected in series with a lamp for heat generation and lighting according to the results of the first and second steps.

5. The control method of claim 4, wherein the set temperature in the first step is 10° C.

6. The control method of claim 4, wherein the third step comprises:
turning the relay off and turning the switch on to operate the lamp when it is determined that the temperature of the outside air is lower than the set temperature in the first step and when it is determined that the door is opened in the second step.

7. The control method of claim 4, wherein the third step comprises:
turning the relay on and the switch off to operate the lamp through the diode when it is determined that the temperature of the outside air is lower than the set temperature in the first step and when it is determined that the door is closed in the second step.

8. The control method of claim 4, wherein the third step comprises:
turning the relay off and the switch on to operate the lamp when it is determined that the temperature of the outside air is higher than or equal to the set temperature in the first step and when it is determined that the door is opened in the second step.

9. The control method of claim 4, wherein the third step comprises:
turning the relay off and the switch off when it is determined that the temperature of the outside air is higher than or equal to the set temperature in the first step and when it is determined that the door is closed in the second step.
